(19) United States
(12) Patent Application Publication
(10) Pub. No.: US 2012/0169231 A1
(43) Pub. Date: Jul. 5, 2012

(54) CIRCUIT ARRANGEMENT FOR OPERATING A LIGHT EMITTING DIODE

(75) Inventors: Mustafa Dinc, Heilbronn (DE); Norbert Pieper, Selb (DE)

(73) Assignee: VISHAY ELECTRONIC GMBH, Selb (DE)

(21) Appl. No.: 13/288,357

(22) Filed: Nov. 3, 2011

(30) Foreign Application Priority Data
Nov. 8, 2010 (DE) 102010050747.4

(51) Int. Cl. B60Q 1/00

(52) U.S. Cl. 315/77

(57) ABSTRACT

A circuit arrangement for operating at least one light emitting diode, in particular for a motor vehicle, includes: a communications device which is connectable to a data bus and which is adapted for receiving control signals from the data bus; a control device connected to the communications device; and a control circuit connected to the control device for the clocked control of a switching regulator which is adapted for providing an operating current for operating the light emission diode, with the control device being adapted for controlling the control circuit on the basis of the control signals received by the communications device.

The invention relates to a circuit arrangement for operating at least one light emitting diode, in particular for a motor vehicle.

Advances in the development of light emitting diodes, in particular in white high-performance light emitting diodes, have also made them increasingly interesting for use in the automotive sector, for example for lighting purposes in the passenger compartment of the vehicle or externally at the vehicle. Since light emitting diodes of this type require a constant operating current, they cannot be directly connected to the onboard power supply of a motor vehicle because the onboard power supply voltage has certain fluctuations. A constant current source is consequently required for the operation of light emitting diodes since otherwise the service life of the light emitting diodes is substantially reduced.

A connection to corresponding switching members is furthermore necessary to switch the light emitting diodes on and off. This is done via door contacts, for example, in a motor vehicle passenger compartment lighting. It is furthermore desirable to be able to switch the passenger compartment lighting on or off with a delay or to regulate the brightness.

A substantial wiring effort and the use of relatively complex circuits for controlling the light emitting diodes are needed to realize these arrangements.

It is therefore the object of the invention to provide a circuit arrangement of the initially named kind which enables a versatile operation of light emitting diodes, in particular in a motor vehicle, and is inexpensive to manufacture.

The object is satisfied by the features of claim 1 and in particular by a circuit arrangement for operating at least one light emitting diode, in particular for a motor vehicle, having a communications device which is connectable to a data bus and which is at least adapted for receiving control signals from the data bus, having a control device connected to the communications device and having a control circuit connected to the control device for the clocked control of a switching regulator which is adapted for providing an operating current for operating the light emitting diode, wherein the control device is adapted for controlling the control circuit on the basis of the control signals received by the communications device.

The circuit arrangement in accordance with the invention makes it possible to control one or more light emitting diodes having a plurality of operating modes in a simple manner. The supply voltage required for operating the light emitting diodes is, for example, provided by the onboard power supply of the motor vehicle, whereas the control signals for controlling the light emitting diode are transmitted via the data bus and are converted by the control device into corresponding control signals for the switching regulator. Actuation commands can thereby be received by a plurality of actuating members connected to the data bus without a separate line connection to the circuit arrangement having to be provided for each actuating member.

Such a data bus can, for example, be a so-called LIN bus, where LIN stands for “local interconnect network”. Such a LIN bus is a one-wire bus which uses a signal line and the ground potential of the supply voltage as the reference potential. A device which can be controlled via the LIN bus thus only has to have three terminals, namely for the plus pole and the minus pole or the ground potential of the supply voltage, as well as a terminal for the signal line of the LIN bus. Control signals are transmitted via the LIN bus at a relatively low data rate, with common data rates being 2,400 bits/s; 9,600 bits/s; and 19,200 bits/s. The circuit arrangement in accordance with the invention can generally also be used for other bus types, for example for a CAN bus.

The circuit arrangement in accordance with the invention is not only adapted for controlling an individual light emitting diode, but so-called light emitting diode strings, that is light emitting diodes arranged in a row, or light emitting diode arrays, that is a plurality of rows of light emitting diodes connected in parallel, can rather thus also be controlled.

The circuit arrangement can be used, for example, for controlling light emitting diodes of a passenger compartment lighting integrated into the headliner of a motor vehicle, of a door lighting or of an external lighting. With a suitable control via the data bus, it is possible to increase or to decrease the brightness of the light emitting diodes continuously on the switching on and off or to change the brightness of the lighting by the user or automatically, for instance in dependence on the ambient light. The user can furthermore, for example, transmit control signals via a radio key to the circuit arrangement in accordance with the invention so that it operates the light emitting diodes in a flashing mode so that the user can easily find his parked motor vehicle in the dark, too.

In accordance with an advantageous embodiment of the invention, the circuit arrangement includes the light emitting diode. The light emitting diode and the circuit arrangement for its operation thus form a unit.

It is preferred if the circuit arrangement has a temperature sensor for determining the temperature of the light emitting diode and the control device is furthermore adapted to control the control circuit on the basis of the temperature of the light emitting diode. Since the service life of light emitting diodes, in particular high-performance light emitting diodes, greatly reduces at too high an operating temperature, the temperature-dependent control of the control circuit allows the operating current of the light emitting diode to be regulated so that the light emitting diode is always operated below a maximum permitted operating temperature.

The circuit arrangement preferably has a temperature sensor thermally coupled to the light emitting diode for this purpose. This temperature sensor can in particular be a diode of a switching regulator coupled to the circuit arrangement which is arranged spatially in the vicinity of the light emitting diode. Since the forward bias of a diode depends on its operating temperature, this forward bias can be monitored and the operating current for operating the light emitting diode can be regulated on the basis of the forward bias.

In accordance with a further advantageous embodiment, the circuit arrangement includes the switching regulator. The switching regulator is preferably a DC converter, for example a step-up converter, a step-down converter or a combination of step-up converter and step-down converter also called a SEPIC converter. The use of a SEPIC converter in particular allows a flexible adaptation to the number of light emitting diodes connected in series or to the level of the available supply voltage. An electronic switch required for operating the switching regulator can either be integrated in the control circuit or provided as an external component.

In accordance with a further advantageous embodiment, the circuit arrangement has a common substrate, in particular a thin film substrate, on which at least the communications device, the control device and the control circuit are provided. Such a technology in which naked or unhoused semiconductor chips are mounted on a substrate, for example a thin-film substrate, for instance by means of soldering or adhesive bonding, is also called COB (chip-on-board) technology. After the mounting of the individual semiconductor chips, that is of the communications device, the control device and the control circuit, and optionally of further assemblies, on the substrate, they are optionally bonded and can subsequently be molded together.

The COB technology allows shorter line paths between individual semiconductor chips or the other assemblies so that the circuit arrangement can be operated at a higher clock frequency. In addition, the sensitivity of the circuit arrangement with respect to external interference radiation falls. A further advantage comprises that such an arrangement of the naked unhoused semiconductor chips on the substrate allows a substantially higher integration density with respect to a conventional arrangement of housed semiconductor chips on a printed circuit board (PCB). This is in particular of advantage in automotive technology since a circuit arrangement, for instance, including the light emitting diodes and the switching regulator can be realized approximately on the same construction space as a conventional lighting device provided with incandescent lamps. There is moreover an advantage in a thermal respect due to the substantially higher efficiency of light emitting diodes with respect to incandescent lamps.

In accordance with a further advantageous embodiment, at least the communication device and the control device, preferably additionally also the control circuit, are integrated in a common integrated circuit. Such an integrated circuit is, for example a semiconductor chip on the basis of a silicon carrier substrate. The communications device, the control device and optionally also the control circuit are thus integrated in a single semiconductor chip so that the required construction space is thereby reduced even further. It is, however, also possible to integrate the control device and the control circuit in a single common integrated circuit.

The switching regulator preferably has a plurality of components which include at least one inductor, at least one capacitor, at least one diode, in particular a Schottky diode, and preferably at least one resistor, with at least one of these components being arranged on the substrate or integrated in the integrated circuit. An even more compact construction of the circuit arrangement can be realized by the integration of individual components or of all components of the switching regulator on the substrate or even in the integrated circuit.

The light emitting diode and preferably also the temperature sensor are preferably arranged on the substrate or integrated into the integrated circuit. It is possible to arrange a semiconductor chip forming the light emitting diode on the substrate or even to the arrange the light emitting diode on the common integrated circuit. This also applies accordingly to the temperature sensor, in particular to a diode of the switching regulator simultaneously serving as a temperature sensor.

In accordance with a preferred embodiment, the control device is a microcontroller which is in particular programmable by means of programming signals received by the communications device from the data bus. It is thus possible, for example, to store individual time intervals for the initially mentioned dimming processes or the flashing frequency in the microcontroller. This can in particular take place at any desired point in time in that corresponding programming signals are transmitted to the circuit arrangement via the data bus. The change of operating parameters of the circuit arrangement can thus also take place after a completed installation of the circuit arrangement into a motor vehicle.

The communications device is preferably a transceiver which is adapted for receiving and for transmitting control signals from and to the data bus. The evaluation circuit can thereby not only receive control signals from the data bus, but also transmit signals to the data bus. It is thus possible, for example, to transmit error messages to the data bus, for example on the failure of individual light emitting diodes or other malfunctions of the circuit arrangement.

The light emitting diode is preferably integrated into an operating element adjustable between a plurality of operating positions, in particular a switch, with the control signals received by the communications device including a position signal which corresponds to the current operating position of the operating element and with the control device furthermore being adapted to control the control circuit on the basis of the position signal. The light emitting diode can therefore be integrated into a switch as background lighting, for example, with the operating position (position of the circuit) being transmitted to the data bus and being detected by the circuit arrangement via the communications device. The circuit arrangement in accordance with the invention can thus be used to signal the current switching state of a device of the vehicle, e.g. a windshield wiper, actuated by a switch to the user on the basis of the operating position of this switch. The circuit arrangement only has to evaluate the control signal of the switch anyway applied to the data bus for this purpose. An operating position is not only to be understood as a mechanical position of an operating element formed as a switch, but rather generally as a switching state which is brought about by the operating element and which can be changed via an operating element formed, for example, as a push button. The operating position can furthermore also include the instantaneous resistance value of a potentiometer, e.g. of a dimming potentiometer of an instrument lighting.

In accordance with a preferred embodiment, the control signals received by the communications device include an ambient light signal and the control device is furthermore adapted to control the control circuit on the basis of the ambient light signal. The ambient light signal can, for example, be provided by an ambient light sensor which is coupled to the data bus so that, for example, the brightness of the lighting can be controlled—as already mentioned above—in dependence on the ambient light. Furthermore, for example, a circuit arrangement which is designed as a passenger compartment lighting and which is controlled by means of a door contact coupled to the data bus on an opening of a vehicle door is only activated when the ambient light falls below a specific threshold without an additional control device being required for this function.

Further advantageous embodiments of the invention are set forth in the dependent claims, in the description and in the drawings.

The invention will be described in the following with reference to embodiments and to the drawing. There are shown:

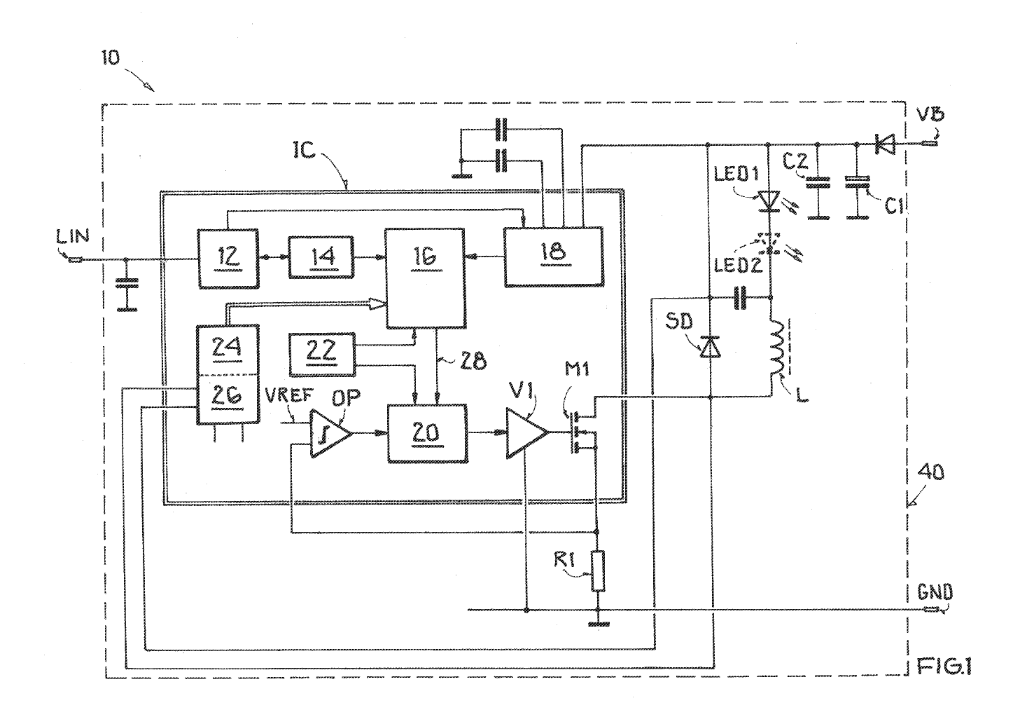

FIG. 1 a circuit diagram of a circuit arrangement in accordance with the invention in accordance with a first embodiment;

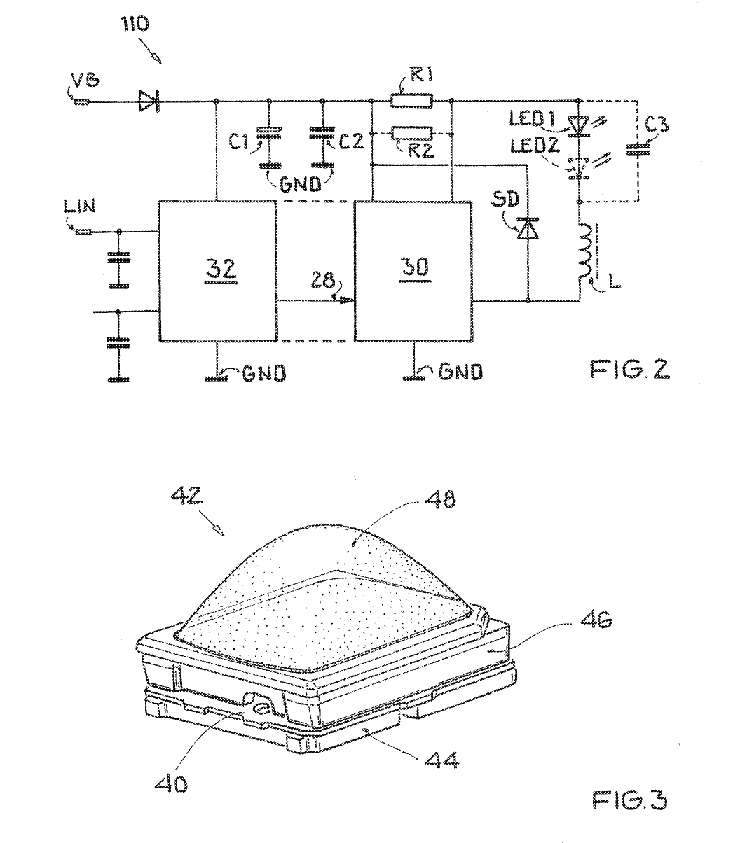

FIG. 2 a circuit diagram of a circuit arrangement in accordance with the invention in accordance with a second embodiment; and

FIG. 3 a perspective view of a circuit arrangement in accordance with the invention integrated into a housing.

A circuit arrangement 10 in accordance with the invention includes a substrate 40, for example a single-layer or multi-layer thin-film substrate, on which an integrated circuit IC as well as a plurality of discrete components still to be explained in more detail are arranged. The circuit arrangement 10 has a terminal VB for an operating voltage, for example a 12 V voltage of a motor vehicle onboard power supply, a terminal GND for a common ground and a terminal LIN for a LIN signal line of a LIN bus.

A control signal received at the terminal LIN is transmitted by a LIN transceiver 12 via a UART interface module 14 to a microcontroller 16. The connection between the LIN transceiver 12 and the microcontroller 16 is bidirectional, i.e. signals can also be transmitted from the microcontroller 16 to the LIN bus, for example error messages.

A voltage supply 18 supplies the microcontroller 16 as well as further circuits of the circuit arrangement 10 with a stabilized supply voltage.

The microcontroller 16 generates a pulse width modulated (PWM) control signal on the basis of the control signals received by the LIN bus and transmits it via a PWM control signal line 28 to a switching regulator driver 20. The modulation frequency preferably amounts to more than 200 Hz. The switching regulator driver 20 generates a radio frequency clocked control signal on the basis of the PWM control signal with which a MOS transistor M1 of a switching regulator known per se and deigned as a step down converter is controlled via an amplifier V1. The frequency of the clocked control signal amounts to up to 2 MHz.

The switching regulator includes an inductor L, two capacitors C1, C2 and a Schottky diode SD. The components forming the switching regulator can, for example, be adhesively bonded or soldered onto the substrate 40 in the form of SMD components. If the switching frequency at which the MOS transistor M1 is controlled amounts to more than 600 kHz, the inductor L can also be integrated directly into the substrate. Further passive components such as the capacitors C1, C2 and C3 (FIG. 2) and/or the shunt resistors R1 and R2 (FIG. 2) can also be integrated into the substrate 40.

The switching regulator converts an operating voltage into an operating current which flows through two light emitting diodes LED1, LED2 connected in series. The operating current furthermore flows across a shunt resistor R1 and generates a voltage drop there. In an operational amplifier OP, a difference signal is generated from the voltage measured across R1 and a reference voltage VREF and is provided at an input of the switching regulator driver 20 to regulate the operating current to a predefined desired value. Operating currents up to 1 A can be provided using the circuit arrangement.

An oscillator 22 supplies both the microcontroller 16 and the switching regulator driver 20 with a system clock frequency.

The forward bias of the Schottky diode SD is a measure for its temperature so that, with a spatial arrangement which ensures a thermal coupling of the Schottky diode SD to the light emitting diodes LED1, LED2, a regulation of the operating current of the light emitting diodes LED 1, LED2 can take place in dependence on the temperature. The Schottky diode SD has a positive temperature coefficient, i.e. The increase in the forward bias signals an increase in the operating temperature of the light emitting diodes LED 1, LED2.

To measure the forward bias of the Schottky diode SD and for the subsequent digitizing of the measured value, the integrated circuit IC has a multiplexer 26 and an analog/digital converter 24 arranged after it. The digitized measured value is transmitted to the microcontroller 16. If the operating temperature exceeds a predefined limit value, the microcontroller 16 changes the PWM control signal such that the switching regulator drive 20 reduces the operating current so much that the temperature of the light emitting diodes LED1, LED2 again falls below the limit value.

A mask (not shown) can be provided on the substrate which covers all the components except for the light emitting diodes LED1, LED2.

The light emitting diodes LED1, LED2 can, for example, serve as a passenger compartment lighting for a motor vehicle. Some purely exemplary operating routines of the circuit arrangement 10 will be described in the following for this application.

If the circuit arrangement 10 receives a control signal at the terminal LIN which requests a switching on of the passenger compartment lighting, the microcontroller 16 controls the switching regulator drive 20 such that the operating current increases continuously within a time interval predefined in the microcontroller 16 until a maximum operating current is reached which is in turn stored in the microcontroller 16. Conversely, on the arrival of a control signal for switching off the lighting at the terminal LIN, a continuous reduction or regulating down of the operating current to zero takes place. The microcontroller 16 can furthermore be programmed so that the switching off or the continuous regulating down of the light emitting diodes LED1, LED2 only takes place at the end of a predefinable delay time.

In an advantageous embodiment, the circuit arrangement 10 can additionally receive, at the terminal LIN, an ambient light signal of an ambient light sensor (not shown) coupled to the LIN bus, said ambient light signal being a measure for the ambient light. In this embodiment, the switching on of the passenger compartment lighting only takes place when the ambient light falls below a specific threshold value so that the passenger compartment light is only activated in darkness.

Programming signals can furthermore be transmitted via the LIN bus via which, for example, the duration of the time interval for the switching on and off procedure or the level of the operating current for setting a desired brightness can be changed. This allows a very comfortable and flexible user-specific adaptation of the operating modes of the passenger compartment lighting.

The switching arrangement 10 can furthermore be used as an instrument lighting for a dashboard of a vehicle. In this application, the above-mentioned ambient light signal can be used to control the brightness of the instrument lighting so that, e.g. with increasing ambient brightness, the brightness of the instrument lighting is increased in order always to ensure an ideal contrast.

FIG. 2 shows a circuit arrangement 110 modified with respect to the circuit arrangement 10 of FIG. 1 which corresponds in its operation, however, to the circuit arrangement 10 of FIG. 1. In this respect, elements having the same reference numerals also have the same function.

Unlike the circuit arrangement 10, the switching regulator of the circuit arrangement 110 of FIG. 2 optionally has a further shunt resistor R2 connected in parallel to the shunt resistor R1. A further capacity C3 is optionally furthermore connected in parallel to the light emitting diodes LED 1, LED2. A better adaptation to the desired operating parameters of the switching regulator can thus be achieved. Furthermore, no temperature monitoring of the light emitting diodes LED1, LED2 is provided in the circuit arrangement 110. This can, however, optionally take place by monitoring the forward bias of the Schottky diode SD in accordance with the circuit arrangement 10 of FIG. 1 or by means of a separate temperature sensor.

Instead of a single integrated circuit IC, the circuit arrangement 110 has a control circuit 30 and a further circuit 32.

Those components and circuits are integrated in the control circuit 30 which correspond to the switching regulator driver 20, the operational amplifier OP, the amplifier V1 and the MOS transistor M1 of FIG. 1.

Those components and/or circuits are integrated in the circuit 32 which correspond to the LIN transceiver 12, the UART interface module 14, the microcontroller 16, the voltage supply 18, the analog-digital converter 24 and the multiplexer 26 of FIG. 1. A PWM control signal is transmitted via the PWM control signal line 28 from the circuit 32 to the control circuit 30. An oscillator is not shown in FIG. 2, but can be provided as an external component or in one or both circuits 30, 32.

Generally, the two circuits 30, 32 can also be integrated in one single circuit, which is indicated by dashed lines.

Although in the two circuit arrangements 10, 110, the inductor L, the capacitors C1 to C3, the shunt resistors R1, R2, the Schottky diode SD and the light emitting diodes LED 1, LED2 are provided as discrete components, it is possible to provide them in part or in full on the integrated circuit IC or in the control circuit 30.

It would therefore ultimately be possible to integrate the circuit arrangement 10 or 110 respectively in a single integrated circuit or semiconductor chip. An extremely compact construction of a light emitting diode lighting element is thereby possible.

An exemplary lighting element 42 is shown in FIG. 3. It includes a carrier plate 44 on which a substrate 40 is arranged with a circuit arrangement 10 or 110 in accordance with FIG. 1 or FIG. 2 respectively. A frame 46 which surrounds the components (not visible) arranged on the substrate 40 is arranged on the side of the substrate 40 disposed opposite the carrier plate 44. The light emitting diodes are in this respect arranged so that they can irradiate light upwardly in the direction of the drawing without impediment.

The interior of the frame 46 is molded with a transparent casting compound 48, with the casting compound 48 forming a convex meniscus. This provides a divergent irradiation of the light generated by the light emitting diodes.

### REFERENCE NUMERAL LIST

10, 110 circuit arrangement
12 LIN transceiver
14 UART interface module
16 microcontroller
18 voltage supply
20 switching regulator driver
22 oscillator
24 analog/digital converter
26 multiplexer
28 PWM control signal line
30 control circuit
32 circuit
40 substrate
42 lighting element
44 carrier plate
46 frame
48 casting compound
VB terminal for operating voltage
GND terminal for ground potential
LIN terminal for LIN signal line
IC integrated circuit
LED 1, LED2 light emitting diode
L inductor
C1-C3 capacitor
SD Schottky diode
R1, R2 shunt resistor
OP operational amplifier
M1 MOS transistor
V1 amplifier
VREF reference voltage

1. A circuit arrangement for operating at least one light emitting diode (LED1, LED2), in particular for a motor vehicle, comprising:
a communications device (12, 14) which is connectable to a data bus and which is adapted at least for receiving control signals from the data bus;
a control device (16) connected to the communications device (12, 14); and
a control circuit (20, 30) connected to the control device (16, 32) for the clocked control of a switching regulator which is designed for providing an operating current for operating the light emitting diode (LED1, LED2),
wherein the control device (16, 32) is adapted for controlling the control circuit (20, 30) on the basis of the control signals received by the communications device (12, 14).

2. A circuit arrangement in accordance with claim 1,
wherein the data bus is a LIN bus.

3. A circuit arrangement in accordance with claim 1,
wherein the circuit arrangement (10, 110) includes the at least one light emitting diode (LED1, LED2).

4. A circuit arrangement in accordance with claim 3,
wherein the circuit arrangement (10, 110) is adapted for determining the temperature of the at least one light emitting diode (LED1, LED2), wherein the control device (16, 32) is furthermore adapted for controlling the control circuit (20, 30) on the basis of the temperature of the at least one light emitting diode (LED1, LED2).

5. A circuit arrangement in accordance with claim 4,
wherein the circuit arrangement (10, 110) has a temperature sensor thermally coupled to the at least one light emitting diode (LED1, LED2).

6. A circuit arrangement in accordance with claim 5,
wherein the temperature sensor has a Schottky diode (SD) whose forward bias represents an operating temperature of the Schottky diode, with the Schottky diode being a part of the switching regulator.

7. A circuit arrangement in accordance with claim 1,
wherein the circuit arrangement (10, 110) includes the switching regulator.

8. A circuit arrangement in accordance with claim 7,
wherein the switching regulator is a DC converter.

9. A circuit arrangement in accordance with claim 1,
wherein the circuit arrangement (10, 110) has a common substrate (40), in particular a thin-film substrate, on which at least the communications device (12, 14), the control device (16, 32) and the control circuit (20, 30) are provided.

10. A circuit arrangement in accordance with claim 9,
wherein the switching regulator has a plurality of components which include at least one inductor (L), at least one capacitor (C1-C3) and at least one diode, in particular a Schottky diode (SD), with the plurality of components being arranged on the common substrate (40).

11. A circuit arrangement in accordance with claim 9,
wherein the circuit arrangement (10, 110) includes the at least one light emitting diode (LED1, LED2), and wherein the at least one light emitting diode is arranged on the common substrate (40).

12. A circuit arrangement in accordance with claim 1,
wherein at least the communications device (12, 14) and the control device (16, 32), preferably additionally also the control circuit (20, 30), are integrated in a common integrated circuit (IC).

13. A circuit arrangement in accordance with claim 12,
wherein the switching regulator has a plurality of components which include at least one inductor (L), at least one capacitor (C1-C3) and at least one diode, in particular a Schottky diode (SD), with at least one of the components being integrated in the common integrated circuit (IC).

14. A circuit arrangement in accordance with claim 12,
wherein the circuit arrangement (10, 110) includes the at least one light emitting diode (LED1, LED2), and wherein the at least one light emitting diode is integrated in the common integrated circuit (IC).

15. A circuit arrangement in accordance with claim 1,
wherein the control device is a microcontroller (16, 32) which is programmable by means of programming signals which are received from the data bus via the communications device (12, 14).

16. A circuit arrangement in accordance with claim 1,
wherein the communications device (12, 14) includes a transceiver (12) which is adapted for receiving control signals from the data bus and for transmitting control signals to the data bus.

17. A circuit arrangement in accordance with claim 1,
wherein the at least one light emitting diode (LED1, LED2) is integrated into an operation element, in particular into a switch, adjustable between a plurality of operating positions, with the control signals received by the communications device (12, 14) including a position signal which corresponds to the current operating position of the operating element, and wherein the control device (16, 32) is furthermore adapted for controlling the control circuit (20, 30) on the basis of the position signal.

18. A circuit arrangement in accordance with claim 1,
wherein the control signals received by the communications device (12, 14) include an ambient light signal, and wherein the control device (16, 32) is furthermore adapted for controlling the control circuit (20, 30) on the basis of the ambient light signal.
